(19) United States
(12) Patent Application Publication
(10) Pub. No.: US 2011/0271605 A1
(43) Pub. Date: Nov. 10, 2011

(54) FINE GRAINED CEMENTED CARBIDE POWDER MIXTURE WITH LOW SINTERING SHRINKAGE AND METHOD OF MAKING THE SAME

(75) Inventor: Jan Qvick, Virsbo (SE)

(73) Assignee: SECO TOOLS AB, Fagersta (SE)

(21) Appl. No.: 13/145,117

(22) PCT Filed: Feb. 16, 2010
(86) PCT No.: PCT/SE2010/050178

§ 371 Date: Jul. 19, 2011

(30) Foreign Application Priority Data
Feb. 19, 2009 (SE) 0900216-3

(51) Int. Cl. C01B 31/34; B24D 3/06

(52) U.S. Cl. 51/309; 423/440

(57) ABSTRACT

A fine grained cemented carbide powder mixture for cutting tool inserts for metal machining includes WC-powder with a Scott density of 2.75-3.75 g/cm³ and a compacting density after dry pressing at 100 MPa within 8.8-9.8 g/cm³. The sintering shrinkage of the fine grained cemented carbide powder mixture is 16.8 to 17.9% at a compacting pressure of 150 MPa. A method of making the powder mixture is also described.

The present invention relates to a fine grained cemented carbide powder with low sintering shrinkage, particularly useful for cutting tool inserts for turning, milling and drilling of metals and a method of making the same

Cemented carbide is made by wet milling of powders forming hard constituents and binder phase to a slurry, drying the slurry generally by spray drying, tool pressing the dried powder to inserts of desired shape and finally sintering.

During sintering, the inserts shrink about 16-20% linearly. The shrinkage depends on pressing pressure, WC grain size, grain size distribution and Co-content. Pressing tools are expensive to make and are therefore made for a standard shrinkage such as 17.5%. The shrinkage is determined at a standard pressing pressure. If the shrinkage at the standard pressure is high, the pressing pressure at the predetermined shrinkage will be high. If the shrinkage at the standard pressure is low, the pressing pressure at the predetermined shrinkage will be low. A high pressing pressure is not desirable because of the risk of pressing cracks in the pressed bodies and abnormal wear and even risk of pressing tool failure including injuries to humans. A too low pressing pressure may lead to parts that are not fully dense after sintering. Moreover, dimensional control of the sintered part is facilitated if the pressing pressure is kept within a certain interval. Inserts produced with a high pressing pressure often show edges with pressing cracks.

EP 1043413 discloses a method of making a cemented carbide with fine grained WC grain size with a low compacting pressure. The method consists in premixing all components except WC for about three hours, adding the WC powder and then finally milling for about ten hours.

EP 1749601 discloses a method of making a ready to press cemented carbide powder with low compaction pressure suitable for the production of fine grained cemented carbide. The method comprises using 1-3 wt-% pressing agent of the following composition, <90 wt-% PEG and 10-75 wt-% of blends of high molecular weight (C12-<C20) saturated or unsaturated fatty acids, or salts thereof containing at least one element of Al, Ba, Ca, Co, Cr, Mg, N, Na, V, Zn.

EP 1739197 discloses a method of making cemented carbide at which powders forming hard constituents and powders forming binder phase are wet milled together with a pressing agent. A cemented carbide powder with a reduced compacting pressure at a predetermined weighing in of 18% shrinkage can be obtained by using from about 1 to about 3 wt-% pressing agent with the following composition: less than about 90 wt-% PEG and greater than about 10 wt-% of long chain C>=20 fatty acids, their esters and salts, in particular, erucic acid and/or behenic acid.

It has now surprisingly been found that a fine grained cemented carbide powder mixture with a reduced sintering shrinkage at a constant pressing pressure can be made from powder mixtures made of a tungsten carbide with a relatively high Scott density.

According to the invention there is now provided a fine grained cemented carbide powder mixture with desired low sintering shrinkage and excellent compacting properties for cutting tool inserts for metal machining comprising fine grained WC and 4-15 wt-% Co, preferably 5-14 wt-% Co, conventional pressing agents and possibly grain growth inhibitors such as <1 wt-% Cr, preferably 0.2-0.6 wt-% Cr and/or <1 wt-% V, preferably 0.2-0.6 wt-% V and/or <1 wt-% Ta and/or <1 wt-% Nb and/or <1 wt-% Ti.

The fine grained cemented carbide powder mixture has a sintering shrinkage of 16.8 to 17.9%, preferably within 17.0 to 17.7% at a compacting pressure of 150 MPa.

The WC-powder has an FSSS grain size in the range 0.4-1.7 μm, preferably 0.5-1.5 μm. It has a relatively high Scott density (ISO 3923 Part 2) of 2.75-3.75 g/cm3 and a compacting density after dry pressing without pressing agent at 100 MPa within 8.8-9.8 g/cm³, preferably 8.9-9.5 g/cm³. The compacting density of the WC is determined by weighing and measuring the dimensions of the compacted body.

The present invention also relates to a method of making a cemented carbide powder with low sintering shrinkage and excellent compacting properties for cutting tool inserts for metal machining comprising fine grained WC and 4-15 wt-% Co, preferably 5-14 wt-% Co, conventional pressing agents and possibly grain growth inhibitors such as <1 wt-% Cr, preferably 0.2-0.6 wt-% Cr and/or <1 wt-% V, preferably 0.2-0.6 wt-% V and/or <1 wt-% Ta and/or <1 wt-% Nb and/or <1 wt-% Ti by means of the powder metallurgical techniques wet milling, dry pressing and sintering.

The WC-powder has an FSSS grain size in the range 0.4-1.7 μm, preferably 0.5-1.5 μm. It has a relatively high Scott density (ISO 3923 Part 2) of 2.75-3.75 g/cm³ and a compacting density after dry pressing without pressing agent at 100 MPa within 8.8-9.8 g/cm³, preferably 8.9-9.5 g/cm³.

### EXAMPLE 1

### Invention

A fine grained cemented carbide powder with the composition WC-6 wt-% Co, 0.3 wt-% Cr₃C₂, 2.0 wt-% PEG 3400 and 0.5 wt-% PEG 1500 was prepared. The Fisher Sub Sieve Sizer value of the WC was 0.82 μm, the Scott density was 2.87 g/cm³ and the compacting density after dry pressing without pressing agent at 100 MPa was 9.04 g/cm³ by weighing and measuring the dimensions of the compacted body.

The cemented carbide powder batch was spray dried and compacted to bodies with the approximate size 15×15×7 mm at the standard pressure 150 MPa. The bodies were sintered at 1430° C. at standard sintering conditions. The exact dimensions of the bodies were determined before and after sintering.

The linear shrinkage of the bodies was 17.4% and the coercivity was 24.7 kA/m.

### EXAMPLE 2

### Prior Art

Example 1 was repeated with the exception that the WC had a Fisher Sub Sieve Sizer value of 0.81 μm, a Scott density of 2.31 g/cm³ and a compacting density after dry pressing without pressing agent at 100 MPa of 8.44 g/cm³.

The linear shrinkage of the bodies was 18.3% and the coercivity was 24.9 kA/m.

### EXAMPLE 3

### Invention

Example 1 was repeated with the exception that the Co-content was 13%.

The linear shrinkage of the bodies was 17.3% and the coercivity was 18.2 kA/m.

### EXAMPLE 4

### Prior Art

Example 3 was repeated with the exception that the WC had a Fisher Sub Sieve Sizer value of 0.81 μm, a Scott density of 2.31 g/cm³ and a compacting density after dry pressing without pressing agent at 100 MPa of 8.44 g/cm³.

The linear shrinkage of the bodies was 18.3% and the coercivity was 18.3 kA/m.

### EXAMPLE 5

### Invention

A fine grained cemented carbide powder with the composition WC-6 wt-% Co, 0.2 wt-% TaC, 1.5 wt-% PEG 3400 and 0.5 wt-% PEG 1500 was prepared. The Fisher Sub Sieve Sizer value of the WC was 1.37 μm, the Scott density was 2.99 g/cm³ and the compacting density after dry pressing without pressing agent at 100 MPa was 9.15 g/cm³ by weighing and measuring the dimensions of the compacted body.

The cemented carbide powder batch was spray dried and compacted to bodies with the approximate size 15×15×7 mm at the standard pressure 150 MPa. The bodies were sintered at 1430° C. at standard sintering conditions. The exact dimensions of the bodies were determined before and after sintering.

The linear shrinkage of the bodies was 17.2% and the coercivity was 16.9 kA/m.

### EXAMPLE 6

### Prior Art

Example 5 was repeated with the exception that the WC had a Fisher Sub Sieve Sizer value of 1.42 μm, a Scott density of 2.38 g/cm³ and a compacting density after dry pressing without pressing agent at 100 MPa of 8.40 g/cm³.

The linear shrinkage of the bodies was 18.2% and the coercivity was 16.7 kA/m.

Thus, Examples 1-6 show that the use of a fine grained WC-powder with a relatively high Scott density and compacting density gives a fine grained cemented carbide powder mixture with a low sintering shrinkage.

1. Fine grained cemented carbide powder mixture for cutting tool inserts for metal machining characterised in that the WC-powder has a Scott density of 2.75-3.75 g/cm³ and a compacting density after dry pressing at 100 MPa within 8.8-9.8 g/cm³ and the sintering shrinkage of the fine grained cemented carbide powder mixture is 16.8 to 17.9% at a compacting pressure of 150 MPa.

2. Fine grained cemented carbide powder mixture for cutting tool inserts for metal machining according to claim 1 characterised in comprising WC-powder with an FSSS grain size of 0.4-1.7 μm and 4-15 wt-% Co.

3. A method of making a fine grained cemented carbide powder mixture for cutting tool inserts for metal machining characterised in using a WC-powder with a Scott density of 2.75-3.75 g/cm³ and a compacting density after dry pressing at 100 MPa of 8.8-9.8 g/cm³.

4. A method of making a fine grained cemented carbide powder mixture for cutting tool inserts for metal machining according to claim 3 characterised in using a WC-powder with an FSSS grain size of 0.4-1.7 μm and 4-15 wt-% Co.
